(19) United States
(12) Patent Application Publication
(10) Pub. No.: US 2007/0241674 A1
(43) Pub. Date: Oct. 18, 2007

(54) ORGANIC ELECTROLUMINESCENT DISPLAY OLED AND FABRICATION METHOD THEREOF

(75) Inventors: Ching-Ian Chao, Hsinchu (TW); Hsia-Tsai Hsiao, Hsinchu (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU OPTRONICS CORP., Hsinchu (TW)

(21) Appl. No.: 11/672,148

(22) Filed: Feb. 7, 2007

(30) Foreign Application Priority Data
Apr. 13, 2006 (TW) 95113152

(51) Int. Cl. H01J 1/62; H01J 63/04

(52) U.S. Cl. 313/506

(57) ABSTRACT

An OLED apparatus and fabrication method thereof. The apparatus includes a substrate, an OLED device overlying the substrate, a passivation layer overlying the OLED device, and a protective film, thicker than the passivation layer, overlying the passivation layer.

### BACKGROUND OF THE INVENTION

1. Field of the Invention

The invention relates to display technology and in particular to organic electroluminescent display.

2. Description of the Related Art

Recently, more and more flat panel displays utilize organic light emitting diodes (OLEDs) as illumination devices therein due to their flexibility, low power consumption, low operating voltage, high brightness, light weight and slim profile, portability, wide viewing angle, high contrast ratio, and lack of ghost images and stacking images.

Packaging is a key process in fabrication of OLED devices because the organic materials and cathodes therein tend to be damaged by oxygen and moisture. Thus, effective protection against invasive oxygen and moisture is a critical aspect of the package structures thereof. In FIG. 1, a conventional display device utilizing thin film encapsulation for an OLED device is shown. A gas barrier passivation layer 120 is formed overlying an OLED 110 overlying a substrate 100 to protect the OLED 100 from oxygen and moisture and reduce weight and size of the display. The thin film encapsulation may further be applied to top emitting displays and flexible displays. The advantages of the thin film encapsulation comprise decreasing the thickness and weight of the display panel, and reduction of costs of encapsulating materials and desiccant.

The passivation layer 120, while effectively protecting the OLED 110 from oxygen and moisture, provides no mechanical protection for the encapsulated OLED. The exposed passivation layer 120 can be easily scraped during IC bonding and module process, damaging the cathode and the organic layer of the OLED device, negatively affecting the process yield of the display. Further, oxygen and moisture may diffuse into the encapsulated OLED from such scrapes on the exposed passivation layer 120, negatively affecting display reliability.

U.S. Pat. No. 6,882,383 and TW patent No. 1236310 and 1234414 disclose formation of another passivation layer overlying the passivation layer 120. The added structure, however, still fails to provide mechanical protection for the encapsulated OLED.

### BRIEF SUMMARY OF THE INVENTION

Organic electroluminescent displays and fabrication methods thereof are provided.

The invention provides an organic electroluminescent displays comprising a substrate, an OLED device, a passivation layer, and a protective film. The OLED device overlies the substrate. The passivation layer overlies the OLED device. The protective film, thicker than the passivation layer, overlies the passivation layer.

The invention further provides a method for fabricating an OLED apparatus. First, a substrate is provided. An OLED device is then formed overlying the substrate. Further, a passivation layer is formed overlying and encapsulating the OLED device. Finally, a protective film, thicker than the passivation layer, is formed overlying the passivation layer.

The invention further provides a method for fabricating an OLED apparatus. First, a substrate is provided. An OLED device is then formed overlying the substrate. Next, a passivation layer is formed overlying and encapsulating the OLED device. Further, an adhesion layer is formed on the substrate, in the proximity of the passivation layer. Finally, a protective film is attached to the adhesion layer, spanning the passivation layer.

Further scope of the applicability of the invention will become apparent from the detailed description given hereinafter. It should be understood, however, that the detailed description and specific examples, while indicating preferred embodiments of the invention, are given by way of illustration only, since various changes and modifications within the spirit and scope of the invention will become apparent to those skilled in the art from this detailed description.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a cross-section of a conventional display device utilizing thin film encapsulation for an OLED device;

FIG. 2 is a cross-section of an OLED apparatus of the first embodiment of the invention;

FIG. 3 is a cross-section of an OLED apparatus of the second embodiment of the invention;

FIG. 4 is a cross-section of an OLED apparatus of the third embodiment of the invention; and

FIG. 5 is a cross-section of an OLED apparatus of the fourth embodiment of the invention.

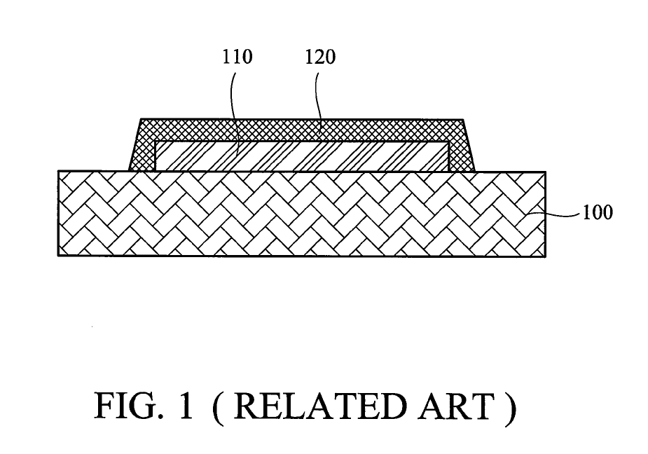

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

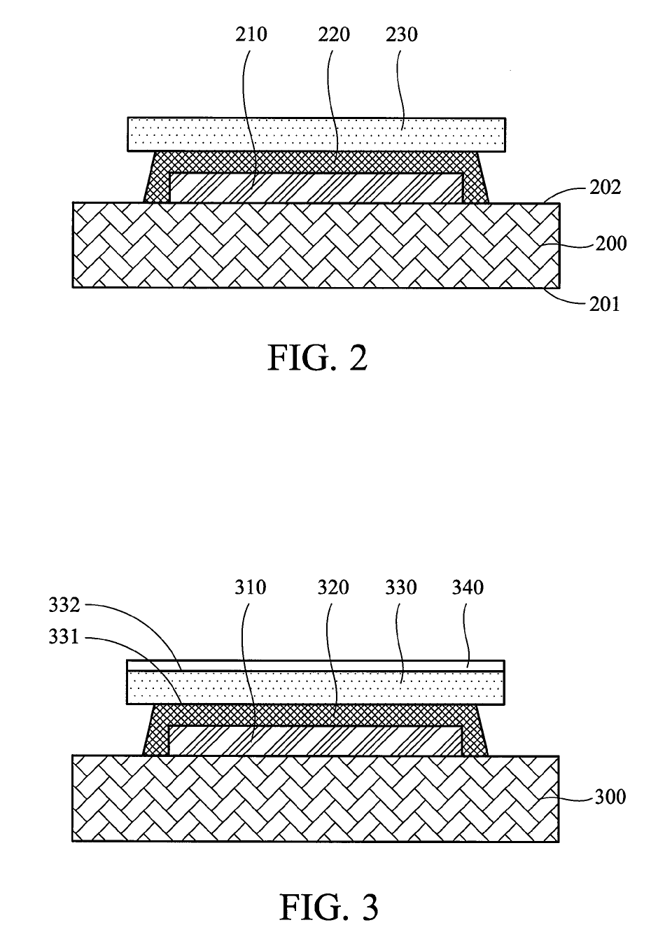

FIG. 2 is a cross-section of an OLED apparatus of the first embodiment of the invention, comprising a substrate 200, an OLED device 210 overlying the substrate 200, a passivation layer 220 overlying the OLED device 210, and a protective film 230, thicker than the passivation layer 220, overlying the passivation layer 220.

In this embodiment, the OLED apparatus is a bottom emitting apparatus. Light from the OLED device 210 is emitted to and through the substrate 200, and further to the space from the bottom surface 201 of the substrate 200. Thus, the substrate 200 is substantially glass or other transparent material. In some embodiments, the substrate 200 may be flexible, such as a transparent plastic material.

The OLED device 210 is formed overlying the top surface 202, of a known combination of multi-layer organic materials, such as electrode layers, a hole injection layer, a hole transport layer, light emitting layers, an electron transport layer, an electron injection layer, or other layers. Those skilled in the art will recognize the possibility of using appropriate materials and formation methods to complete the desired layers of the OLED device 210, and thus, details regarding thereto are omitted herefrom.

The passivation layer 220 typically completely covers and encapsulates the OLED device 210. The passivation layer 220 is typically gas tight materials to prevent oxygen and moisture from entering the OLED device 210. The moisture permeation rate of the passivation layer 220 is preferably less than 10⁻⁶ g/m²/day, and the oxygen permeation rate of the passivation layer 220 is preferably less than 10⁻⁵ cc/bar/m²/day. Thus, the passivation layer 220 is preferably of organic/inorganic multi-layer composite materials. An exemplary formation method of the passivation layer 220 comprise, first, a polymeric sub-layer deposited overlying the substrate 200, covering the OLED device 210, the surface of which comprises an atomic level flatness. A ceramic sub-layer approximately 50 nm thick is then deposited on the polymer sub-layer, followed by repeated alternating formations of polymeric and ceramic sub-layers to complete the multi-layered passivation layer 220, between 2 and 5 μm thick, comprising alternating polymeric and ceramic sub-layers. Those skilled in the art will recognize the possibility of using appropriate materials and formation methods to form the desired sub-layers, completing the desired passivation layer 220, and thus, details regarding thereto are omitted herefrom.

Protective film 230 is formed overlying and completely covering passivation layer 220, providing protection from scraping. In this embodiment, the protective film 230 is preferably tape with at least one surface adhesive. The protective film 230 may comprise polycarbonate (PC), poly(ethylene terephthalate) (PET), poly(methyl methacrylate) (PMMA), or other plastics thereof. The protective film 230 is thicker than the passivation layer 220, between 50 μm and 300 μm thick, for example. When stress is exerted on the apparatus during subsequent process, the protective film 230 successfully protects the underlying passivation layer 220 damaged and scraping. Thus, the passivation layer 220 functions normally to prevent oxygen and moisture in the outside environment from entering the OLED device 210, increasing the process yield and product reliability of the apparatus.

It is not necessary to utilize transparent materials as the passivation layer 220 and protective film 230, since the OLED apparatus of this embodiment is a bottom emitting apparatus. When transparent materials are utilized as the passivation layer 220 and protective film 230, the apparatus may act as a dual emitting apparatus.

FIG. 3 is a cross-section of an OLED apparatus of the first embodiment of the invention, comprising a substrate 300, an OLED device 310 overlying the substrate 300, a passivation layer 320 overlying the OLED device 310, and a protective film 330, thicker than the passivation layer 320, overlying the passivation layer 320.

In this embodiment, the OLED apparatus is a top emitting apparatus. Light from the OLED device 310 passes through the passivation layer 320 and the protective film 330, entering the space from the top surface 332 of the protective film 330. Thus, the substrate 300 may be flexible, such as a transparent plastic material, or rigid substrate, and need not necessarily be transparent. When a substantially transparent material, such as glass, transparent plastic material, or other transparent material, is utilized as the substrate 300, the OLED apparatus of this embodiment may act as a dual emitting apparatus.

Details regarding the OLED device 310, passivation layer 320, and protective film 330, are respectively similar to the OLED device 210, the passivation layer 220, and the protective film 230 of the first embodiment except that, here, the passivation layer 320 and the protective film 330 are transparent, and thus, are omitted herefrom. The light transmittance, relative to light from the OLED device 310, of the protective film 330 is preferably as high as 80% or greater, and thus the apparatus can provide desired brightness. For example, if intensity of light received in the bottom surface 331 of the protective film 330 is A₀, followed by passage through the protective film 330, becoming A₁ when entering the space from the top surface 332 of the protective film 330, and the ratio of (A₁/A₀) is preferably as high as 80% or greater.

Further, an anti-reflection layer 340 composed of ceramic materials such as SiO₂, Si₃N₄, or other materials, can be optionally formed overlying the top surface 332 of the protective film 330 to decrease the interface reflection of ambient light and internal emission light between the protective film 330 and the air thereof, enhancing the contrast and the efficiency.

As described, when stress is exerted on the apparatus during subsequent process, the protective film 330 successfully protects the underlying passivation layer 220 from damage or scraping. Thus, the passivation layer 320 still functions normally to prevent oxygen and moisture in the outside environment from entering the OLED device 310, increasing the process yield and product reliability of the apparatus.

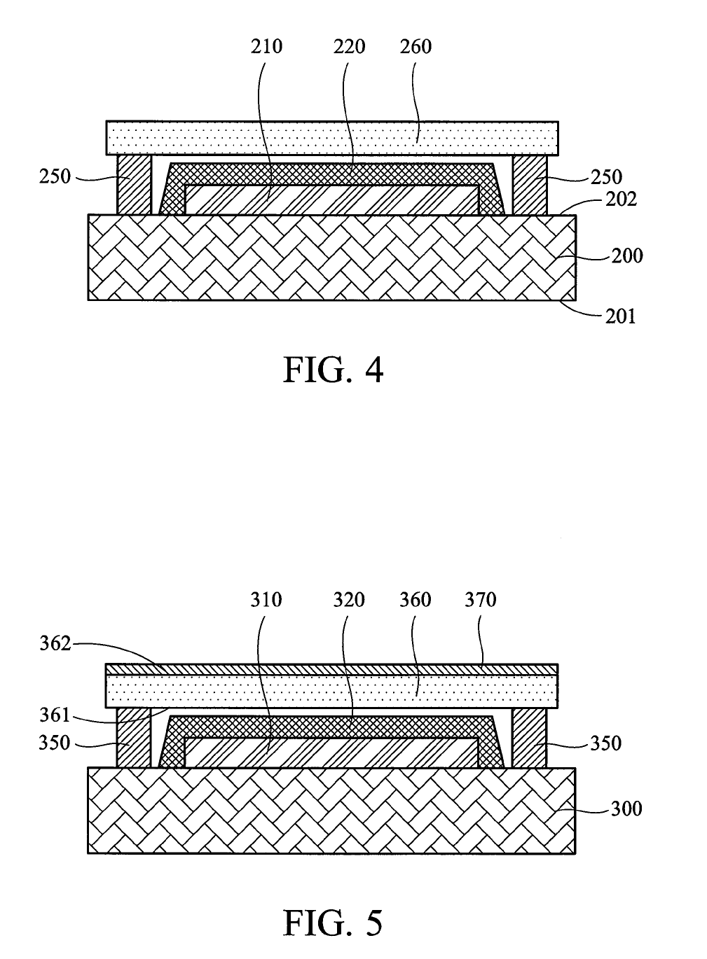

FIG. 4 is a cross-section of an OLED apparatus of the first embodiment of the invention, comprising a substrate 200, an OLED device 210 overlying the substrate 200, a passivation layer 220 overlying the OLED device 210, and a protective film 260, thicker than the passivation layer 220, overlying the passivation layer 220. Details regarding the substrate 200, the OLED device 210, and the passivation layer 220 are the same as those described in the first embodiment, and thus, are omitted herefrom.

In this embodiment, the protective film 260 is attached to an adhesive layer 250, and thus spans the passivation layer 220 without substantial contact therewith. In an alternative embodiment, the protective film 260 may substantially contact the passivation layer 220 as desired. The adhesive layer 250 is typically formed overlying the substrate 200, in the proximity of the passivation layer 220. For example, the adhesive layer 250 may be formed at either side of the passivation layer 220 or surrounding the passivation layer 220. The adhesive layer 250 preferably has original adhesive, and can be cured or hardened by radiation of ultraviolet (UV) light or heat. When hardened, the adhesive layer 250 can be adhesive or not. Thus, the protective film 260, adhesive or not, adheres to the adhesive layer 250, followed by curing or hardening of the adhesive layer 250 to fix the protective film 260, completing the OLED apparatus shown in FIG. 4. Moreover, materials of the protective film 260 are similar to those of the protective film 230 described in the first embodiment, and thus, are omitted herefrom.

FIG. 5 is a cross-section of an OLED apparatus of the first embodiment of the invention, comprising a substrate 300, an OLED device 310 overlying the substrate 300, a passivation layer 320 overlying the OLED device 310, and a protective film 360, thicker than the passivation layer 320, overlying the passivation layer 320.

In this embodiment, the OLED apparatus is a top emitting apparatus. Light from the OLED device 310 passes through the passivation layer 320 and the protective film 360, entering the space from the top surface 362 of the protective film 360. Details regarding the substrate 300, the OLED device 310, and the passivation layer 320 are the same as those described in the second embodiment, and thus, are omitted herefrom.

In this embodiment, the protective film 360 is attached to an adhesive layer 350, and thus spans the passivation layer 320 without substantial contact therewith. In an alternative embodiment, the protective film 360 may substantially contact the passivation layer 320 as desired. The adhesive layer 350 is typically formed overlying the substrate 300, in the proximity of the passivation layer 320. For example, the adhesive layer 350 may be formed at either side of the passivation layer 320 or surrounding the passivation layer 320. The adhesive layer 350 preferably has original adhesive, and can be cured or hardened by radiation of ultraviolet (UV) light or heat. When hardened, the adhesive layer 350 can be adhesive or not. Thus, the protective film 360, adhesive or not, is adhered to the adhesive layer 350, followed by curing or hardening the adhesive layer 350 to fix the protective film 360, completing the OLED apparatus shown in FIG. 5. Moreover, materials of the protective film 360 are similar with those of the protective film 330 described in the second embodiment, and thus, are omitted herefrom.

In this embodiment, the OLED apparatus is a top emitting apparatus. Light from the OLED device 310 passes through the passivation layer 320 and the protective film 330, entering the space from the top surface of the protective film 330. Thus, the substrate 300 may be flexible, such as a transparent plastic material, or rigid substrate, and need not necessarily be transparent. The light transmittance, relative to light from the OLED device 310, of the protective film 360 is preferably as high as 80% or greater, and thus the apparatus can provide desired brightness. For example, if intensity of light received in the bottom surface 361 of the protective film 360 is A₀, followed by passage through the protective film 360, becoming A₁ when emitting to the space from the top surface 362 of the protective film 360, the ratio of (A₁/A₀) is preferably as high as 80% or greater.

Further, an anti-reflection layer 370 composed of ceramic materials, such as SiO₂, Si₃N₄, or other materials, can be optionally formed overlying the top surface 362 of the protective film 360 to decrease the interface reflection of ambient light and internal emission light between the protective film 360 and the air thereof, enhancing the contrast and the efficiency.

OLED apparatuses and fabrication methods thereof are provided, with improved protection from damage and scraping.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An organic light emitting diode (OLED) apparatus, comprising:
a substrate;
an OLED device overlying the substrate;
a passivation layer overlying the OLED device; and
a protective film, thicker than the passivation layer, overlying the passivation layer.

2. The apparatus as claimed in claim 1, wherein the OLED device substantially emits light to the protective film, and the passivation layer and the protective film are substantially transparent.

3. The apparatus as claimed in claim 1, wherein the light transmittance of the protective film is as high as 80% or greater.

4. The apparatus as claimed in claim 2, wherein the protective film further comprises an anti-reflection layer thereon.

5. The apparatus as claimed in claim 1, further comprising an adhesion layer at either side of the passivation layer, and the protective film adheres to the adhesion layer, spanning the passivation layer.

6. The apparatus as claimed in claim 5, wherein the adhesion layer surrounds the passivation layer.

7. The apparatus as claimed in claim 1, wherein the protective film is between 50 μm and 300 μm thick.

8. The apparatus as claimed in claim 1, wherein the protective film is adhesive at the bottom thereof, attaching to the passivation layer thereby.

9. The apparatus as claimed in claim 1, wherein the protective film comprises a plastic material.

10. The apparatus as claimed in claim 9, wherein the protective film comprises polycarbonate (PC), poly(ethylene terephthalate) (PET), poly(methyl methacrylate) (PMMA), or other plastic materials.

11. The apparatus as claimed in claim 1, wherein the substrate is substantially transparent.

12. The apparatus as claimed in claim 1, wherein the substrate is substantially rigid or flexible.

13. The apparatus as claimed in claim 1, wherein the substrate is substantially transparent, and the OLED device substantially emits light to the substrate.

14. A method for fabricating an OLED apparatus, comprising:
providing a substrate;
forming an OLED device overlying the substrate;
forming a passivation layer overlying and encapsulating the OLED device; and
forming a protective film, thicker than the passivation layer, overlying the passivation layer.

15. The method as claimed in claim 14, further comprising forming an anti-reflection layer overlying the protective film.

16. The method as claimed in claim 14, wherein the protective film is between 50 μm and 300 μm thick.

17. The method as claimed in claim 14, wherein the protective film comprises a plastic material.

18. The method as claimed in claim 17, wherein the protective film comprises polycarbonate (PC), poly(ethylene terephthalate) (PET), poly(methyl methacrylate) (PMMA), or other plastic materials.

19. A method of fabricating an illumination apparatus, comprising:
providing a substrate;
forming an OLED device overlying the substrate;
forming a passivation layer overlying and encapsulating the OLED device;
forming an adhesion layer on the substrate, in the proximity of the passivation layer; and
attaching a protective film to the adhesion layer, spanning the passivation layer.

20. The method as claimed in claim 19, further comprising forming an anti-reflection layer overlying the protective film.

21. The method as claimed in claim 19, wherein the protective film is between 50 μm and 300 μm thick.

22. The method as claimed in claim 19, wherein the protective film comprises a plastic material.

23. The method as claimed in claim 19, wherein the protective film comprises polycarbonate (PC), poly(ethylene terephthalate) (PET), poly(methyl methacrylate) (PMMA), or other plastic materials.

24. The method as claimed in claim 19, wherein the adhesion layer is formed at either side of the passivation layer, or surrounding the passivation layer.
